(19) United States
(12) Patent Application Publication
(10) Pub. No.: US 2026/0245974 A1
(43) Pub. Date: Aug. 20, 2026

(54) ELECTRODE ASSEMBLY AND SECONDARY BATTERY COMPRISING ELECTRODE ASSEMBLY

(71) Applicant: SAMSUNG SDI CO., LTD., Yongin-si (KR)

(72) Inventors: Hyung Dong LEE, Yongin-si (KR); Jae Hyung KIM, Yongin-si (KR); Suk Jun KANG, Yongin-si (KR)

(21) Appl. No.: 19/291,941

(22) Filed: Aug. 6, 2025

(30) Foreign Application Priority Data
Feb. 14, 2025 (KR) 10-2025-0019172

(51) Int. Cl. H01M 10/0587; H01M 50/105

(52) U.S. Cl. CPC H01M 10/0587; H01M 50/105

(57) ABSTRACT

An electrode assembly includes a first electrode, a second electrode, a separator between the first electrode and the second electrode, and an adhesive member, the first electrode, the second electrode, and the separator are wound to form a first end corresponding to a start position of winding and a second end corresponding to an end position of winding, the second end is an end of an outermost separator, the adhesive member comprises a first adhesive member and a second adhesive member, the first adhesive member is disposed on an outer surface of the outermost separator, the second adhesive member is disposed on an inner surface of the outermost separator, and the first adhesive member or the second adhesive member comprises a plurality of adhesive parts spaced apart from each other or one another.

### CROSS-REFERENCE TO RELATED APPLICATION

The present application claims priority to and the benefit of Korean Patent Application No. 10-2025-0019172, filed on February 14, 2025, in the Korean Intellectual Property Office, the entire disclosure of which is incorporated herein by reference.

### BACKGROUND

### 1. Field

Embodiments of the present disclosure relate to an electrode assembly and a secondary battery.

### 2. Description of the Related Art

While primary batteries are not designed to be (re)charged, secondary (also known as rechargeable) batteries are batteries that are designed to be discharged and recharged. Among secondary batteries, low-capacity secondary batteries are widely used in portable, small electronic devices, such as smart phones, feature phones, notebook computers, digital cameras, and camcorders, while high-capacity secondary batteries are widely used as power sources for driving motors in hybrid vehicles and electric vehicles, as well as for storing power (e.g., home and/or utility scale power storage). A secondary battery generally includes an electrode assembly including a positive electrode and a negative electrode, a case accommodating both electrodes, and electrode terminals connected to the electrode assembly.

This Background section is for the general understanding of the background of the present disclosure, and therefore, it may contain information that does not constitute related (or prior) art.

### SUMMARY

Embodiments of the present disclosure provide an electrode assembly having reduced appearance wrinkles.

Embodiments of the present disclosure provide a secondary battery having improved electrical capacity.

Embodiments of the present disclosure provide an electrode assembly including a first electrode, a second electrode, a separator between the first electrode and the second electrode, and an adhesive member, the first electrode, the second electrode, and the separator are wound to form a first end an end where winding starts and a second end as n end where winding end, the second end is a winding end of an outermost separator, the adhesive member comprises a first adhesive member and a second adhesive member, the first adhesive member is disposed on an outer surface of the outermost separator, the second adhesive member is disposed on an inner surface of the outermost separator, and at least one of the first adhesive member or the second adhesive member comprises a plurality of adhesive parts spaced apart from each other.

Embodiments of the present disclosure provide an electrode assembly comprising a first electrode, a second electrode, a separator between the first electrode and the second electrode, and an adhesive member, wherein the first electrode, the second electrode, and the separator are wound to form a first end corresponding to a start position of winding and a second end corresponding to an end position of winding, wherein the second end is an end of an outermost separator, wherein the adhesive member comprises a first adhesive member and a second adhesive member, wherein the first adhesive member is disposed on an outer surface of the outermost separator, wherein the second adhesive member is disposed on an inner surface of the outermost separator, and wherein the first adhesive member or the second adhesive member comprises a plurality of adhesive parts spaced apart from each other or one another.

In some embodiments, the first adhesive member comprises a plurality of first adhesive parts, the second adhesive member comprises a plurality of second adhesive parts, the first adhesive member partially overlaps the second end, the second adhesive member does not overlap the second end, the first adhesive member and the second adhesive member comprise different materials.

In some embodiments, the first adhesive member comprises a plurality of a first adhesive part, wherein the second adhesive member comprises a plurality of a second adhesive part, wherein the first adhesive member at least partially overlaps the second end, wherein the second adhesive member does not overlap the second end, wherein the first adhesive member comprises a material different than a material of the second adhesive member.

In some embodiments, the first adhesive part and the second adhesive part partially overlap.

In some embodiments, the first adhesive part and the second adhesive part at least partially overlap each other.

In some embodiments, a melting point of the first adhesive member and a melting point of the second adhesive member are different.

In some embodiments, the first adhesive member has a melting point different than a melting point of the second adhesive member.

In some embodiments, the melting point of the first adhesive member is greater than the melting point of the second adhesive member.

In some embodiments, the first adhesive part and the second adhesive part do not overlap, and the first adhesive part and the second adhesive part are alternately disposed along a longitudinal direction of the second end.

In some embodiments, the first adhesive member comprises a plurality of first adhesive parts, and a length of the second adhesive member is greater than a length of the first adhesive part.

In some embodiments, the electrode assembly further includes an electrode tab connected to the first electrode and the second electrode, the first adhesive member and the second adhesive member do not overlap, the second adhesive member is disposed closer to the electrode tab than the first adhesive member, and a melting point of the second adhesive member is greater than a melting point of the first adhesive member.

Embodiments of the present disclosure provide an electrode assembly including a first electrode, a second electrode, a separator between the first electrode and the second electrode, and an adhesive member, the first electrode, the second electrode, and the separator are wound to form a first end an end where winding starts and a second end as n end where winding end, the second end is a winding end of an outermost separator, the adhesive member and the fixing member are disposed on an outer surface of the outermost separator, the fixing member is disposed at an edge of the adhesive member, and a melting point of the fixing member is greater than a melting point of the adhesive member.

Embodiments of the present disclosure provide an electrode assembly comprising a first electrode, a second electrode, a separator between the first electrode and the second electrode, an adhesive member, and a fixing member, wherein the first electrode, the second electrode, and the separator are wound to form a first end corresponding to a start position of winding and a second end corresponding to an end position of winding, wherein the second end is an end of an outermost separator, wherein the adhesive member and the fixing member are disposed on an outer surface of the outermost separator, wherein the fixing member is disposed at at least an edge of the adhesive member, and wherein a melting point of the fixing member is greater than a melting point of the adhesive member.

In some embodiments, the fixing member surrounds the edge of the adhesive member.

In some embodiments, the fixing member surrounds an entirety of the edge.

In some embodiments, the fixing member is disposed in a portion of the edge of the adhesive member.

In some embodiments, the electrode assembly further includes an electrode tab connected to the first electrode and the second electrode, the fixing member comprises a first fixing part and a second fixing part, the first fixing part is disposed closer to the electrode tab than the second fixing part, and a width of the first fixing part is greater than a width of the second fixing part.

Embodiments of the present disclosure provide an electrode assembly including a first electrode, a second electrode, a separator between the first electrode and the second electrode, and an adhesive member, the first electrode, the second electrode, and the separator are wound to form a first end an end where winding starts and a second end as n end where winding end, the second end is a winding end of an outermost separator, the second end comprises a first line and a second line extending in different directions, the adhesive member is disposed on the first line and the second line, the adhesive member on the first line extends in the longitudinal direction of the first line, and the adhesive member on the second line extends in the longitudinal direction of the second line.

Embodiments of the present disclosure provide an electrode assembly comprising a first electrode, a second electrode, a separator between the first electrode and the second electrode, and a plurality of an adhesive member, wherein the first electrode, the second electrode, and the separator are wound to form a first end corresponding to a start position of winding and a second end corresponding to an end position of winding, wherein the second end is an end of an outermost separator, wherein the second end comprises a first line and a second line extending in different directions, wherein one or more of the plurality of the adhesive member is disposed on each of the first line and the second line, wherein the adhesive member on the first line extends in the longitudinal direction of the first line, and wherein the adhesive member on the second line extends in the longitudinal direction of the second line.

In some embodiments, the first line and the second line are perpendicular to each other.

In some embodiments, the second line extends in a diagonal direction of the first line.

In some embodiments, the first line and the second line are not perpendicular to each other.

Embodiments of the present disclosure provide a secondary battery comprising: a case; and an electrode assembly of accommodated in the case, wherein the first electrode comprises a first electrode tab, wherein the second electrode comprises a second electrode tab, wherein the first electrode tab is connected to a first lead, and wherein the second electrode tab is connected to a second lead.

In some embodiments, the first adhesive member comprises a plurality of a first adhesive part, wherein the second adhesive member comprises a plurality of a second adhesive part, wherein the first adhesive member at least partially overlaps the second end, wherein the second adhesive member does not overlap the second end, wherein the first adhesive member comprises a material different than a material of the second adhesive member.

In some embodiments, the material of the first adhesive member comprises polystyrene or polyethylene, and wherein the material of the second adhesive member comprises a silicon-based binder, an acrylate-based binder, or polyvinylidene fluoride.

In some embodiments, a melting point of the first adhesive member is greater than a melting point of the second adhesive member.

In some embodiments, the first adhesive member and the second adhesive member do not overlap, the second adhesive member is disposed closer to the electrode tab than the first adhesive member, and a melting point of the second adhesive member is greater than a melting point of the first adhesive member.

### BRIEF DESCRIPTION OF THE DRAWINGS

The drawings illustrate embodiments of the present disclosure, and further describe aspects and features of the present disclosure along with the detailed description of the present disclosure. Thus, the present disclosure should not be construed as being limited to the drawings:

FIG. 1 is a perspective view showing a secondary battery according to embodiments of the present disclosure.

FIG. 2 is a side view of showing an electrode assembly after winding according to embodiments of the present disclosure.

FIG. 3 is a side view showing the electrode assembly according to embodiments of the present disclosure.

FIG. 4 is a side view showing the electrode assembly according to embodiments of the present disclosure.

FIG. 5 is a side view showing the electrode assembly according to embodiments of the present disclosure.

FIG. 6 is a side view showing the electrode assembly according to embodiments of the present disclosure.

FIG. 7 is a side view showing the electrode assembly according to embodiments of the present disclosure.

FIG. 8 is a side view showing the electrode assembly according to embodiments of the present disclosure.

FIG. 9 is a side view showing the electrode assembly according to embodiments of the present disclosure.

FIG. 10 is a separator showing the electrode assembly according to embodiments of the present disclosure.

FIG. 11 is a side view showing the electrode assembly according to embodiments of the present disclosure.

FIG. 12 is the separator of the electrode assembly according to embodiments of the present disclosure.

FIG. 13 is a side view showing the electrode assembly according to embodiments of the present disclosure.

FIG. 14 is a perspective view showing a battery pack including battery modules according to embodiments of the present disclosure.

FIG. 15 is a perspective view showing a battery pack including battery modules according to embodiments of the present disclosure.

FIG. 16 is a perspective view showing a vehicle including battery packs according to embodiments of the present disclosure.

FIG. 17 is a side view showing a vehicle including battery packs according to embodiments of the present disclosure.

### DETAILED DESCRIPTION

Embodiments of the present disclosure are described, in detail, with reference to the accompanying drawings. The terms or words used in the present specification and claims are not to be limitedly interpreted as general or dictionary meanings and should be interpreted as meanings and concepts that are consistent with the technical idea of the present disclosure on the basis of the principle that an inventor can be his/her own lexicographer to appropriately define concepts of terms to describe his/her invention in the best way.

The embodiments described in this specification and the configurations shown in the drawings are only some of the embodiments of the present disclosure and do not represent all of the technical spirit, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being "coupled" or "connected" to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of "may" when describing embodiments of the present disclosure relates to "one or more embodiments of the present disclosure." Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms "substantially," "about," and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or "over" the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms "includes," "including," “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of "1.0 to 10.0" is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or "over" the other elements or features. Thus, the term “below” may encompass both an orientation of above and below. The device may be otherwise oriented (rotated 90 degrees or at other orientations), and the spatially relative descriptors used herein should be interpreted accordingly.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being "linked," "coupled," or "connected" to another component, the elements may be directly “coupled,” “linked” or "connected" to each other, or another component may be "interposed" between the components".

Throughout the specification, when "A and/or B" is stated, it means A, B or A and B, unless otherwise stated. That is, “and/or” includes any or all combinations of a plurality of items enumerated. When "C to D" is stated, it means C or more and D or less, unless otherwise specified.

As used herein, the terms are for describing embodiments of the present disclosure and are not intended to limit the disclosure.

Depending on the geometry, a secondary battery may be classified into a cylindrical geometry, a prismatic geometry, a pouch geometry, or a coin geometry . The secondary battery described in the present disclosure may be applied to a pouch-type secondary battery.

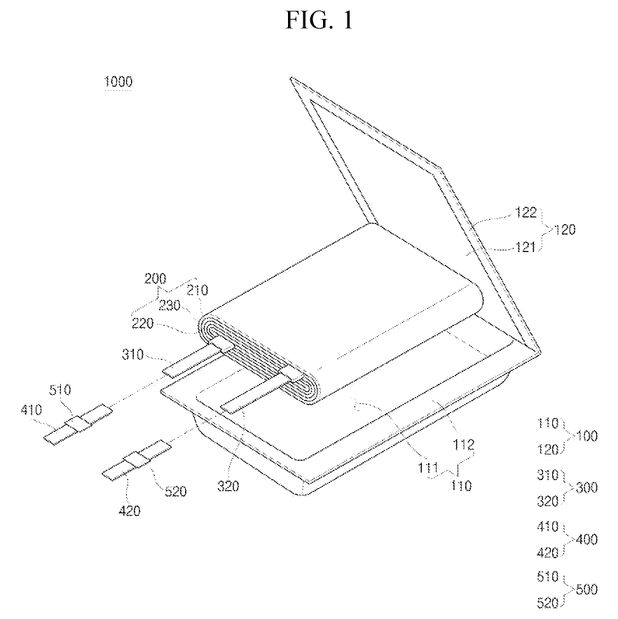

Referring to FIGS. 1 to 6, a secondary battery 1000 may include a case 100 and an electrode assembly 200.

The case 100 may include an accommodation part 110 and a cap part 120. The accommodation part 110 and the cap part 120 may be connected. The case 100 may be formed in a pouch geometry.

The accommodation part 110 may include a concave part 111 and a first sealing part 112. The accommodation part 110 may include an accommodating space. The accommodation part 110 may include an inner bottom surface and an inner side formed by the concave part 111. The accommodating space may be defined by the bottom surface and the inner side.

The first sealing part 112 may be disposed at an edge of the accommodation part 110. A sealing layer may be disposed on the first sealing part 112.

The cap part 120 may include a cover part 121 and a second sealing part 122.

The cover part 121 may cover the accommodation part 110. The cover part 121 may cover the electrode assembly 200 accommodated in the accommodation part 110.

The second sealing part 122 may be disposed at the edge of the cap part 120. The sealing layer may be disposed on the second sealing part 122. The first sealing part 112 and the second sealing part 122 may overlap each other. The accommodation part 110 is covered by the cap part 120, and the first sealing part 112 and the second sealing part 122 may face each other. The accommodation part 110 and the cap part 120 may be bonded by the sealing layer.

The electrode assembly 200 may be accommodated in the case 100. The electrode assembly 200 may be accommodated in the accommodating space of the case. The electrode assembly 200 may be accommodated in the accommodating space together with the electrolyte.

One electrode assembly is illustrated as being accommodated in the case. However, the embodiment is not limited thereto. Two or more electrode assemblies may be accommodated in the case.

The electrode assembly 200 may include a first electrode 210, a second electrode 220, and a separator 230. The electrode assembly 200 may include an adhesive member 600. The electrode assembly 200 may be formed by winding the first electrode 210, the second electrode 220, and the separator 230. For example, the electrode assembly 200 may be formed by winding the first electrode 210, the second electrode 220, and the separator 230 in a jelly roll geometry. The electrode assembly 200 may include a core part 250.

The first electrode 210 may include a first current collector and a first active material layer. The first current collector may include a metal foil such as aluminum or an aluminum alloy. The first active material layer may include a transition metal oxide. For example, the first electrode 210 may be a positive electrode.

The first electrode 210 may be connected to a first electrode tab 310. The first active material layer is not disposed on the first electrode tab 310. The first electrode tab 310 may be welded to the first current collector. The first electrode tab 310 may be integrated with the first current collector. For example, the first electrode tab may include a first uncoated portion on which the first active material layer is not disposed. The first uncoated portion may be notched. The first uncoated portion may be the first electrode tab 310. The first electrode tab 310 may include substantially the same material as the first current collector.

The first electrode tab 310 may include at least one first electrode tab. The first electrode tab may include a plurality of electrode tabs, and the plurality of first electrode tabs may be welded to each other.

The second electrode 220 may include a second current collector and a second active material layer. The second current collector may include a metal foil such as copper, a copper alloy, nickel, or a nickel alloy. The second active material layer may include graphite or carbon. For example, the second electrode 220 may be a negative electrode.

The second electrode 220 may be connected to a second electrode tab 320. The second active material layer is not disposed on the second electrode tab 320. The second electrode tab 320 may be welded to the second current collector. The second electrode tab 320 may be integrated with the second current collector. For example, the second current collector may include a second uncoated portion on which the second active material layer is not disposed. The second uncoated portion may be notched. The second uncoated portion may be the second electrode tab 320. The second electrode tab 320 may include the same material as the second current collector.

The second electrode tab 320 may include at least one second electrode tab. The second electrode tab may include a plurality of electrode tabs, and the plurality of second electrode tabs may be welded to each other.

The separator 230 functions to prevent short circuiting between the first electrode 210 and the second electrode 220 while allowing movement of lithium ions. The separator 230 may include a polyethylene film, a polypropylene film, or a polyethylene-polypropylene film.

The first electrode tab 310 and the second electrode tab 320 may each be connected to a lead. For example, the first electrode tab 310 may be connected to a first lead 410. The first electrode tab 310 may be connected to the first external terminal by the first lead 410. The second electrode tab 320 may be connected to the second lead 420. The second electrode tab 320 may be connected to the second external terminal by the second lead 420. The first lead 410 may include substantially the same material as the first electrode tab. The second lead 420 may include substantially the same material as the second electrode tab.

An insulating layer 500 may be disposed on the lead. The insulating layer may be disposed on a portion of the lead. The insulating layer may surround the lead. For example, a first insulating layer 510 may be disposed on the first lead 410. A second insulating layer 520 may be disposed on the second lead 420. The lead 400 may be insulated from the case 100 by the insulating layer 500.

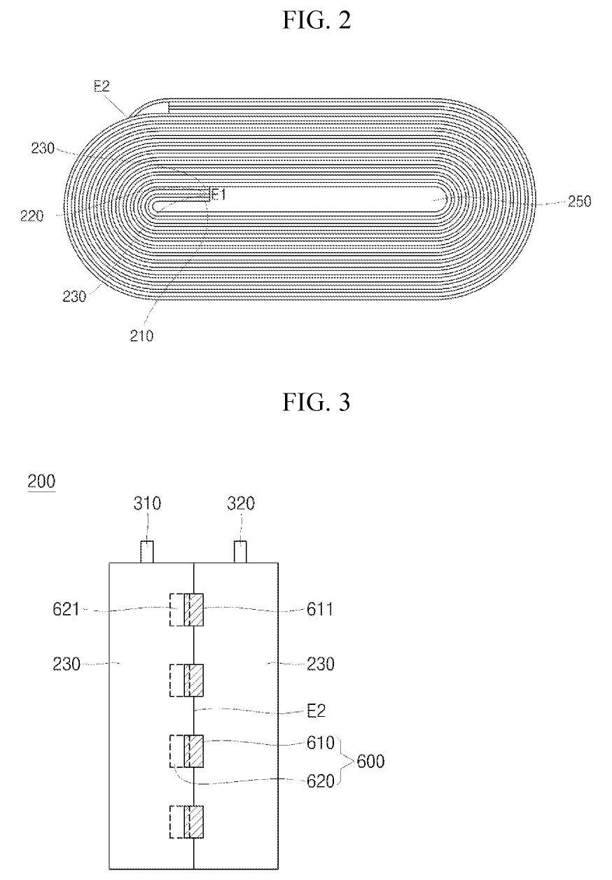

The electrode assembly 200 may be wound in a jellyroll geometry. Referring to FIG. 2, the electrode assembly 200 is wound from the first end E1 to the second end E2. The first end E1 may be an end where winding starts, and the second end E2 may be an end where winding ends. The electrode assembly 200 may be pressurized thereafter. Accordingly, the electrode assembly 200 may be deformed into a shape that may be accommodated in the case 100.

The outermost separator is wound longer than the first electrode, the second electrode, and another separator. The second end E2 may be the end of the outermost separator. The electrode assembly 200 may be fixed at the second end E2. The adhesive member 600 may cover the second end E2. The outermost separator may be adhered by the adhesive member 600. Accordingly, unwinding of the electrode assembly may be prevented where, the adhesive member 600 may be a finishing tape.

The electrode assembly may have an appearance defect due to the adhesive member. The electrode assembly may have a reduced electric capacity due to the adhesive member.

The electrode assembly may be configured to control the position and/or material of the adhesive member.

Referring to FIG. 3, the electrode assembly 200 may include the adhesive member 600. The adhesive member 600 may include a first adhesive member 610 and a second adhesive member 620. The first adhesive member 610 and the second adhesive member 620 may be disposed at different positions.

The first adhesive member 610 may be disposed on an outer surface of the electrode assembly 200. The first adhesive member 610 may be disposed on an outer surface of the outermost separator. The first adhesive member 610 overlaps the second end E2. The first adhesive member 610 partially overlaps the second end E2. The first adhesive member 610 may cover the second end E2. The first adhesive member 610 may include a plurality of first adhesive parts 611. The first adhesive parts may be spaced apart from each other.

The second adhesive member 620 may be disposed on the inner surface of the electrode assembly 200. The second adhesive member 620 may be disposed on the inner surface of the outermost separator. The second adhesive member 620 does not overlap the second end E2. The second adhesive member 620 may include a plurality of second adhesive parts 621. The second adhesive parts may be spaced apart from each other.

The first adhesive member 610 and the second adhesive member 620 may be formed in various sequences. The second adhesive member 620 is formed before the first adhesive member 610. The second adhesive member 620 is formed before the completion of winding of the electrode assembly. The first adhesive member 610 is formed after the completion of winding of the electrode assembly.

The first adhesive member 610 and the second adhesive member 620 may include different materials. The first adhesive member 610 may include an adhesive film. For example, the first adhesive member 610 may include polystyrene (PS) or polyethylene (PE).

The second adhesive member 620 may include a binder. For example, the second adhesive member 620 may include a silicon-based binder, an acrylate-based binder, or polyvinylidene fluoride (PVDF).

The first adhesive member 610 and the second adhesive member 620 may have different physical properties. For example, the first adhesive member 610 and the second adhesive member 620 may have different melting points. For example, the first adhesive member 610 may have a first melting point, and the second adhesive member 620 may have a second melting point. The first melting point may be greater than the second melting point. The first adhesive member 610 may not be easily deformed by heat than the second adhesive member 620.

The second melting point may be less than the first melting point. Therefore, the second adhesive member 620 may be easily deformed by heat than the first adhesive member 610. Because the melting point of the second melting point is relatively low, processing of the second adhesive member may be carried out at a reduced temperature. Therefore, the process efficiency may be improved.

The temperatures of the first melting point and the second melting point may be controlled by adding an additive to the adhesive member.

The first adhesive member 610 and the second adhesive member 620 may overlap each other. The first adhesive member 610 and the second adhesive member 620 may partially overlap each other. For example, the first adhesive member 610 may be disposed on a part of the second adhesive member 620. The second adhesive member 620 may be fixed by the first adhesive member 610.

The adhesive member includes a first adhesive member and a second adhesive member that are disposed at different locations. Accordingly, the adhesive region of the adhesive member may be increased. The second adhesive member is disposed on the inner surface of the outermost separator. Accordingly, even if the adhesive region increases, relatively constant thickness of the electrode assembly may be maintained.

The first adhesive member and the second adhesive member may include a plurality of adhesive parts. Wrinkling of the adhesive member may be reduced. Wrinkling of the first adhesive member may be reduced.

The first adhesive member is disposed on the exterior of the electrode assembly. Accordingly, after the electrode assembly is accommodated in the case, wrinkling of the first adhesive member may be recognized from the exterior of the secondary battery. The degree of wrinkling of the first adhesive member may be proportional to the size of the first adhesive member. To prevent such a wrinkling, the first adhesive member may include a plurality of adhesive parts. wrinkling formed in each bonding portion may be reduced.

The first adhesive member and the second adhesive member may include different materials. Accordingly, the first adhesive member and the second adhesive member may have different melting points, reducing the wrinkling of the first adhesive member. Manufacturing process efficiency of the second adhesive member can be improved.

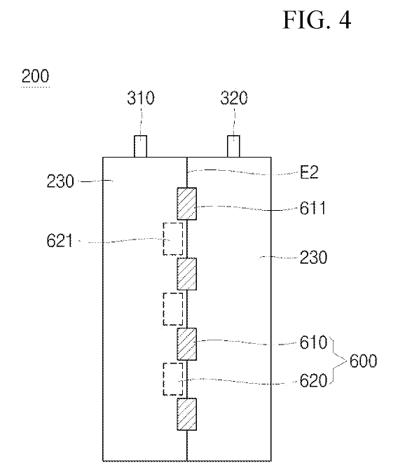

Referring to FIG. 4, the first adhesive member 610 and the second adhesive member 620 may not overlap each other. The first adhesive part 611 and the second adhesive part 621 may be alternately disposed along the longitudinal direction of the second end E2.

Accordingly, the region of the adhesive member disposed along the longitudinal direction of the second end E2 may increase. Therefore, the adhesive strength of the second end E2 may be improved.

The adhesive strength of the first adhesive member may be increased. The thickness of the second adhesive member may increase depending on process error or the material. When the first adhesive member overlaps the second adhesive member, a step may be formed between the overlapping region and the non-overlapping region of the first adhesive member. Adhesive strength of the first adhesive member may be reduced by the step.

Because the first adhesive member does not overlap the second adhesive member, the adhesive strength of the first adhesive member may be maintained.

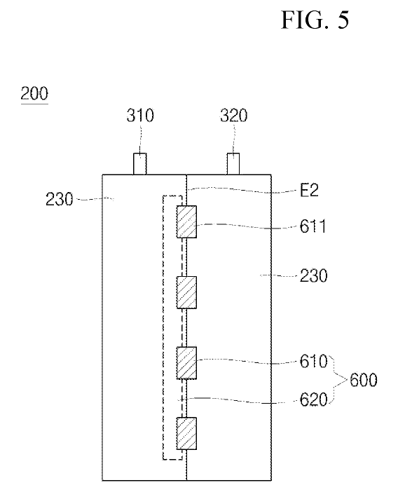

Referring to FIG. 5, the first adhesive member 610 and the second adhesive member 620 may be in different sizes.

For example, the first adhesive member 610 may include a plurality of first adhesive parts 611. The first adhesive parts 611 may be spaced apart along the longitudinal direction of the second end E2.

The second adhesive member 620 may include one adhesive part. The length of the second adhesive member 620 may be greater than the length of the first adhesive part 611. The size of the second adhesive member 620 may have a size greater than that of the first adhesive member 610.

The second adhesive member 620 is disposed on the inner surface of the outermost separator. Any wrinkling of the second adhesive member 620 may be covered by the separator. The wrinkling can be prevented from being visible from the exterior of the secondary battery.

Because the length of the second adhesive member 620 increases, the bonding region of the separator increases. In this manner, unwinding of the electrode assembly may be prevented.

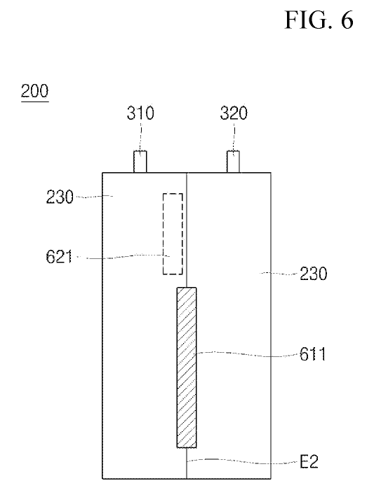

Referring to FIG. 6, the first adhesive member 610 and the second adhesive member 620 may not overlap each other. The first adhesive member 610 and the second adhesive member 620 may be disposed at different positions.

The second adhesive member 620 may be disposed in a region adjacent to the electrode tab 300. The first adhesive member 610 may be disposed in a region distant from the electrode tab 300. The second adhesive member 620 may be closer to the electrode tab 300 than the first adhesive member 610.

The heat from the outside of the electrode assembly may move through the electrode tab. The temperature of the region adjacent to the electrode tab may be higher than the temperature of the distant region. Heat may be transferred to the adhesive member of the region adjacent to the electrode tab. As a result, the adhesive member may be delaminated. Wrinkling may happen in the adhesive member.

The second melting point may be greater than the first melting point. Accordingly, the second adhesive member 620 may not be easily deformed by heat than the first adhesive member 610. The second adhesive member may be prevented from being delaminated. The second adhesive member 620 is disposed on the inner surface of the outermost separator. Any wrinkling of the second adhesive member 620 may be covered by the separator. The wrinkling can be prevented from being visible from the exterior of the secondary battery.

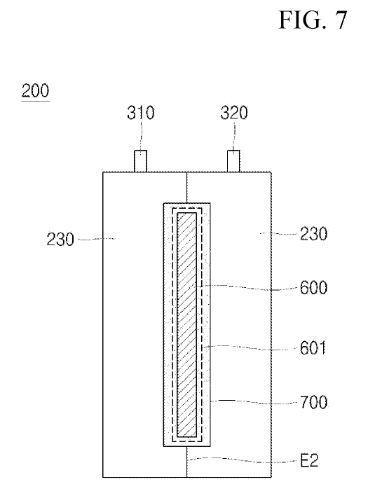

Referring to FIG. 7, the electrode assembly 200 may include a fixing member 700. The electrode assembly may include the first electrode 210, the second electrode 220, the separator 230, the adhesive member 600, and the fixing member 700.

The adhesive member 600 may be disposed on the outer surface of the electrode assembly 200. The adhesive member 600 may be disposed on the outer surface of the outermost separator. The adhesive member 600 overlaps the second end E2. Accordingly, the adhesive member 600 may cover the second end E2.

The fixing member 700 may be disposed on the outer surface of the electrode assembly 200. The fixing member 700 may be disposed on the outer surface of the outermost separator.

The adhesive member 600 and the fixing member 700 may overlap each other. The adhesive member 600 and the fixing member 700 may partially overlap each other. The fixing member 700 may surround the edge 601 of the adhesive member 600.

The adhesive member 600 and the fixing member 700 may have different physical properties. For example, the melting points of the adhesive member 600 and the fixing member 700 may be different. The melting point of the fixing member 700 may be greater than the melting point of the adhesive member 600. Accordingly, the fixing member 700 is not easily deformed by heat than the adhesive member 600.

The adhesive member 600 may include a resin. The adhesive member may be deformed by heat. For example, wrinkling may happen on the surface of the adhesive member. Wrinkling may happen while the edge of the adhesive member is lifted.

The fixing member 700 may surround the edge of the adhesive member 600. Accordingly, lifting of the edge of the adhesive member 600 may be reduced or prevented. The fixing member 700 may include a material having a high melting point. Accordingly, the fixing member 700 is not easily deformed by heat than the adhesive member 600. Wrinkling of the fixing member 700 may be prevented.

Because the adhesive member is prevented from being delaminated, the electrode assembly may be prevented from being unwound during use of the secondary battery.

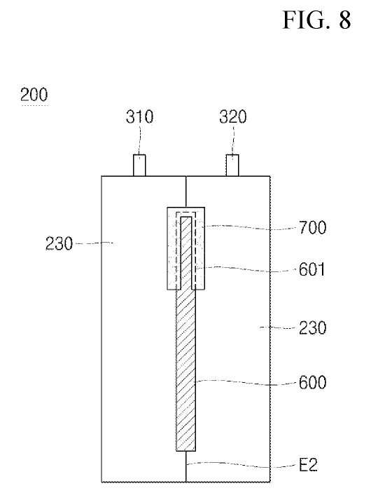

Referring to FIG. 8, the fixing member 700 may be disposed on a portion of the adhesive member 600. The fixing member 700 may be disposed only on the edge of the adhesive member 600 adjacent to the electrode tab 300.

The heat from the outside of the electrode assembly may move through the electrode tab. The temperature of the region adjacent to the electrode tab may be higher than the temperature of the distant region. Heat may be transferred to the adhesive member in the region adjacent to the electrode tab. As a result, the adhesive member may be delaminated. Wrinkling may happen in the adhesive member.

The fixing member 700 is disposed in the area adjacent to the electrode tab. Peeling or wrinkling of the adhesive material may be reduced or prevented.

The fixing member 700 is not disposed in a region far from the electrode tab. The size of the electrode assembly may be maintained due to the existence of the fixing member. any size limitations of the first electrode and the second electrode may be minimized.

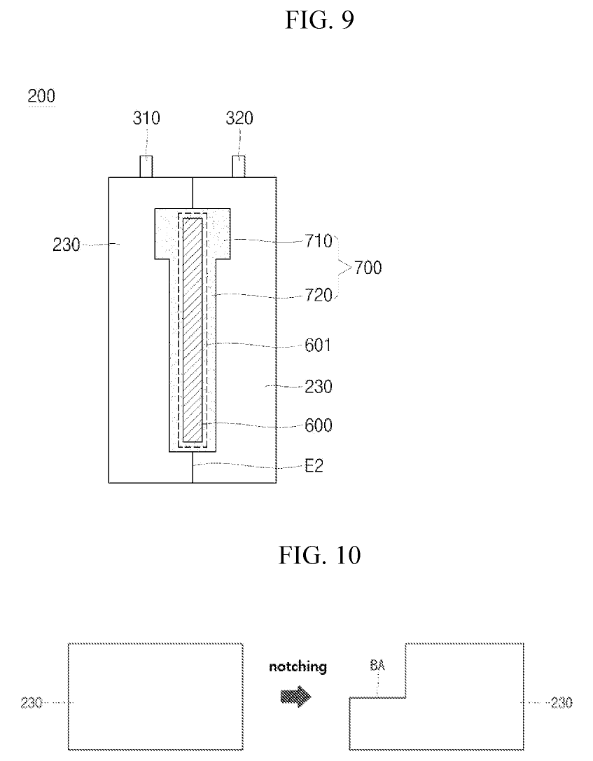

Referring to FIG. 9, the fixing member 700 may include a first fixing member 710 and a second fixing member 720. The first fixing member 710 may be closer to the electrode tab 300 than the second fixing member 720. The first fixing member 710 may be disposed between the electrode tab and the second fixing member 720.

The sizes of the first fixing member 710 and the second fixing member 720 may be different. The width of the first fixing member 710 may be greater than the width of the second fixing member. The fixing member 700 may be disposed with a relatively greater width in a region adjacent to the electrode tab.

The heat from the outside of the electrode assembly may move through the electrode tab. The temperature of the region adjacent to the electrode tab may be higher than the temperature of a distant region. Heat may be transferred to the adhesive member in the region adjacent to the electrode tab. As a result, the adhesive member may be delaminated. Wrinkling may happen in the adhesive member.

The first fixing member 710 is disposed in the region adjacent to the electrode tab. The first fixing member 710 is disposed with a greater width than that of the second fixing member. Accordingly, the adhesive member adjacent to the electrode tab may be strongly fixed by the first fixing member 710. Accordingly, the peeling or wrinkling of the adhesive member may be reduced or prevented.

Referring to FIGS. 10 to 13, the second end E2 may include a bending part BA. The bending part BA may be formed by notching the separator. The separator 230 may be wound after notching. The separator 230 may be notched after winding.

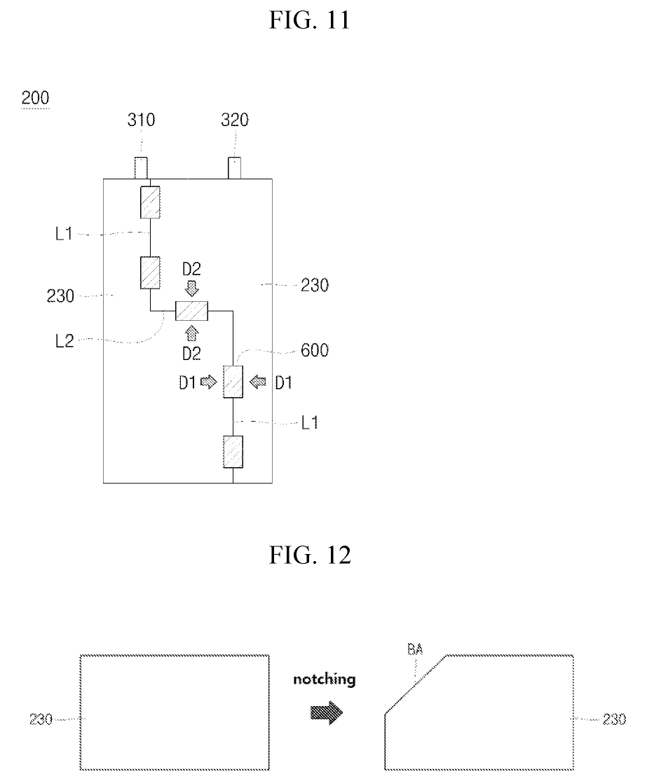

Referring to FIGS. 10 and 11, the second end E2 may include a first line L1 and a second line L2. The second line L2 may correspond to the bending part BA.

The first line L1 and the second line L2 may be perpendicular to each other. The adhesive member 600 may be disposed on each of the first line L1 and the second line L2. The adhesive member 600 of the first line L1 may extend in the longitudinal direction of the first line L1. Accordingly, the separator 230 may be fixed in the first direction D1 by the adhesive member 600 of the first line L1.

The adhesive member 600 of the second line L2 may extend in the longitudinal direction of the second line L2. Accordingly, the separator 230 may be fixed in the second direction D2 by the adhesive member 600 of the second line L2.

The separator may be fixed in multiple directions. Accordingly, the adhesive strength of the separator may be improved. The electrode assembly may be prevented from being unwound during use of the secondary battery.

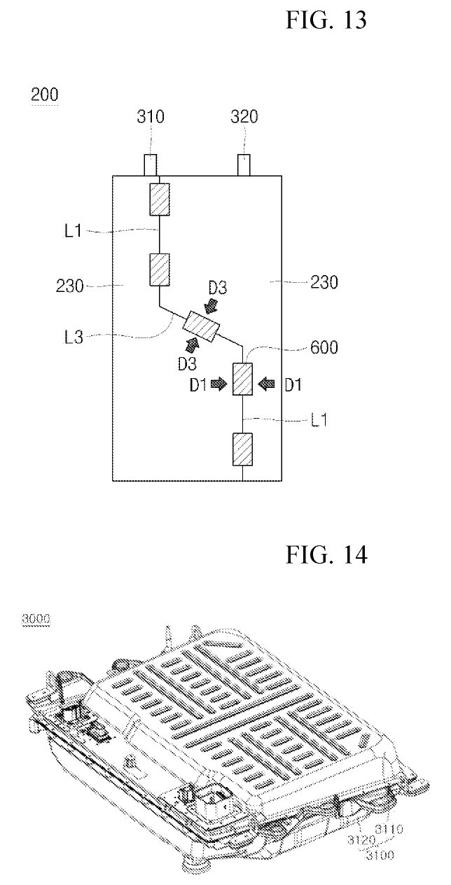

Referring to FIGS. 12 and 13, the second end E2 may include the first line L1 and a third line L3. The third line L3 may correspond to the bending part BA.

The first line L1 and the third line L3 may be inclined. The third line L3 may extend in an inclined direction relative to the first line L1. The adhesive member 600 may be disposed on each of the first line L1 and the third line L3. The adhesive member 600 of the first line L1 may extend in the longitudinal direction of the first line L1. Accordingly, the separator 230 may be fixed in the first direction D1 by the adhesive member 600 of the first line L1.

The adhesive member 600 of the third line L3 may extend in the longitudinal direction of the third line L3. Accordingly, the separator 230 may be fixed in the third direction D3 by the adhesive member 600 of the third line L3.

The separator can be fixed in multiple directions. Accordingly, the adhesive strength of the separator may be improved. The electrode assembly may be prevented from being unwound while the secondary battery is in use.

Conventional electrode assemblies typically have wrinkling on the outer surface. The adhesive member includes a resin, and the resin becomes deformed by heat. As a result, wrinkling was visible on the outer surface of the electrode assembly, dimishing the appearance of the secondary battery.

Conventionally, the size of the electrode assembly was limited by the size of the adhesive member. Accordingly, the capacity of the secondary battery had to be reduced. When the size of the adhesive member is reduced, the bonding area of the adhesive member is reduced. Accordingly, the bonding force of the adhesive member is reduced.

Embodiments of the present disclosure provide an electrode assembly including the adhesive member having a set position and/or material.

The adhesive member includes the first adhesive member and the second adhesive member that are disposed at different positions. Accordingly, the bonding area of the adhesive member may be increased. The second adhesive member is disposed on the inner surface of the outermost separator. Accordingly, even if the bonding area increases, the thickness of the electrode assembly may be maintained.

The first adhesive member and the second adhesive member may include a plurality of bonding parts. Wrinkling of the adhesive member may be reduced. Wrinkling of the first adhesive member may be reduced.

The first adhesive member is disposed on the exterior of the electrode assembly. After the electrode assembly is accommodated in the case, wrinkling of the first adhesive member may be visible from the exterior of the secondary battery. The degree of wrinkling of the first adhesive member may be proportional to the size of the first adhesive member. The first adhesive member may include a plurality of adhesive parts. Wrinkling formed in each adhesive part may be reduced.

The first adhesive member and the second adhesive member may include different materials. Accordingly, the first adhesive member and the second adhesive member may have different melting points, reducing the wrinkling of the first adhesive member. Manufacturing process efficiency of the second adhesive member may be improved.

The secondary battery may be used in portable small electronic devices such as smartphones, feature phones, notebook computers, digital cameras, and camcorders. A battery module and a battery pack including a plurality of secondary batteries may be used as a power source for driving a motor of a hybrid vehicle or an electric vehicle and as a battery for storing power.

The secondary battery may form a battery module. For example, the battery module may include a plurality of secondary batteries. The plurality of secondary batteries may be connected to each other in series, parallel, or series/parallel by a bus bar.

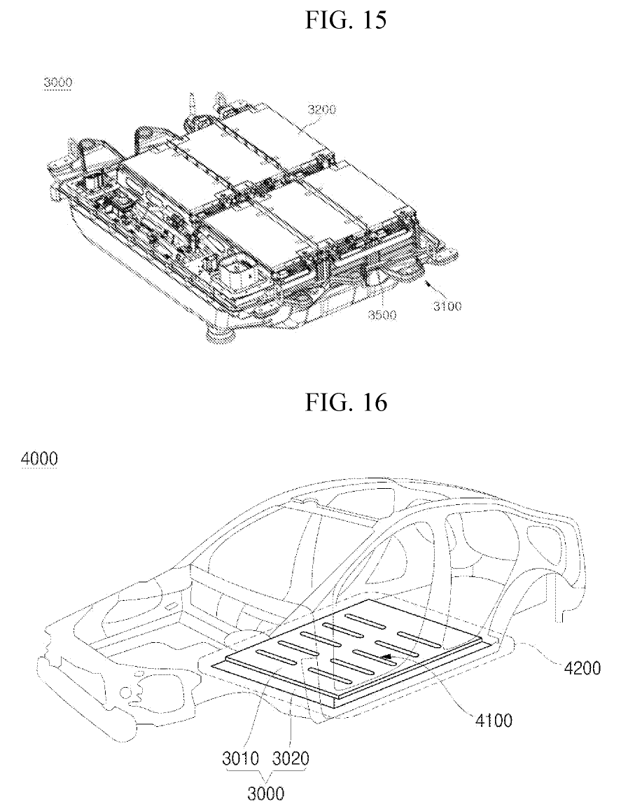

FIGS. 14 and 15 show a battery pack 3000. The battery pack 3000 may include a plurality of battery modules 3200 and a housing 3100 for accommodating the plurality of battery modules 3200. For example, the housing 3100 may include first and second housings 3110 and 3120 coupled in opposite directions through the plurality of battery modules 3200. The plurality of battery modules 3200 may be electrically connected to each other by using a bus bar 3500, and the plurality of battery modules 3200 may be electrically connected to each other in a series/parallel or series-parallel mixed method, thereby obtaining desired (e.g., required) electrical output. In one or more embodiments, battery pack 3300 may be mounted in a vehicle. The vehicle may be or include, for example, an electric vehicle, a hybrid vehicle, or a plug-in hybrid vehicle. A vehicle may include a four-wheeled vehicle or a two-wheeled vehicle.

In FIG. 16, a battery pack 3000 may include a battery pack cover 3010, which is a part of a vehicle underbody 4100 and may correspond to the first housing, and a pack frame 3020, which is disposed under the vehicle underbody 4100 and may corresponding to the second housing. The battery pack cover 3010 and the pack frame 3020 may be, e.g., integrally formed with a vehicle floor 4200. The vehicle underbody 4100 separates the inside and outside of a vehicle, and the pack frame 3020 may be disposed outside the vehicle.

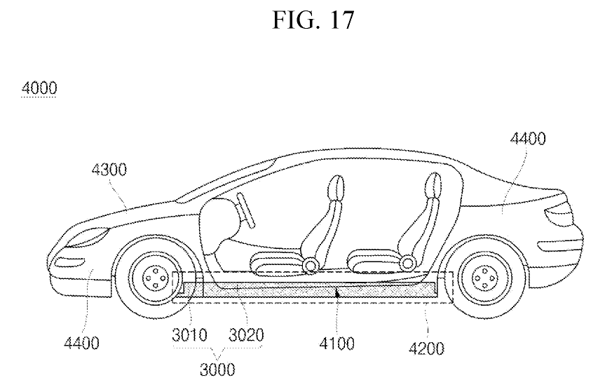

In FIG. 17, a vehicle 4000 may be formed by combining additional parts, such as a hood 4300 in front of the vehicle 4000 and fenders 4400 respectively located in the front and rear of the vehicle 4000 to a vehicle body part. The vehicle 4000 may include the battery pack 3000 including the battery pack cover 3010 and the pack frame 3020, and the battery pack 3000 may be coupled to the vehicle body part.

Although the present disclosure has been described with reference to embodiments and drawings illustrating aspects thereof, the present disclosure is not limited thereto. Various modifications and variations can be made by a person skilled in the art to which the present disclosure belongs within the scope of the technical spirit of the present disclosure.

What is claimed is:

1. An electrode assembly comprising a first electrode, a second electrode, a separator between the first electrode and the second electrode, and an adhesive member,
wherein the first electrode, the second electrode, and the separator are wound to form a first end corresponding to a start position of winding and a second end corresponding to an end position of winding,
wherein the second end is an end of an outermost separator,
wherein the adhesive member comprises a first adhesive member and a second adhesive member,
wherein the first adhesive member is disposed on an outer surface of the outermost separator,
wherein the second adhesive member is disposed on an inner surface of the outermost separator, and
wherein the first adhesive member or the second adhesive member comprises a plurality of adhesive parts spaced apart from each other or one another.

2. The electrode assembly as claimed in claim 1, wherein the first adhesive member comprises a plurality of a first adhesive part,
wherein the second adhesive member comprises a plurality of a second adhesive part,
wherein the first adhesive member at least partially overlaps the second end,
wherein the second adhesive member does not overlap the second end,
wherein the first adhesive member comprises a material different than a material of the second adhesive member.

3. The electrode assembly as claimed in claim 2, wherein the first adhesive part and the second adhesive part at least partially overlap each other.

4. The electrode assembly as claimed in claim 2, wherein the first adhesive member has a melting point different than a melting point of the second adhesive member.

5. The electrode assembly as claimed in claim 4, wherein the melting point of the first adhesive member is greater than the melting point of the second adhesive member.

6. The electrode assembly as claimed in claim 2, wherein the first adhesive part and the second adhesive part do not overlap, and
wherein the first adhesive part and the second adhesive part are alternately disposed along a longitudinal direction of the second end.

7. The electrode assembly as claimed in claim 1, wherein the first adhesive member comprises a plurality of a first adhesive part, and
wherein a length of the second adhesive member is greater than a length of the first adhesive part.

8. The electrode assembly as claimed in claim 1, further comprising an electrode tab connected to the first electrode and the second electrode,
wherein the first adhesive member and the second adhesive member do not overlap,
wherein the second adhesive member is disposed closer to the electrode tab than the first adhesive member, and
wherein a melting point of the second adhesive member is greater than a melting point of the first adhesive member.

9. An electrode assembly comprising a first electrode, a second electrode, a separator between the first electrode and the second electrode, an adhesive member, and a fixing member,
wherein the first electrode, the second electrode, and the separator are wound to form a first end corresponding to a start position of winding and a second end corresponding to an end position of winding,
wherein the second end is an end of an outermost separator,
wherein the adhesive member and the fixing member are disposed on an outer surface of the outermost separator,
wherein the fixing member is disposed at at least an edge of the adhesive member, and
wherein a melting point of the fixing member is greater than a melting point of the adhesive member.

10. The electrode assembly as claimed in claim 9, wherein the fixing member surrounds an entirety of the edge.

11. The electrode assembly as claimed in claim 9, further comprising an electrode tab connected to the first electrode and the second electrode,
wherein the fixing member comprises a first fixing part and a second fixing part,
wherein the first fixing part is disposed closer to the electrode tab than the second fixing part, and
wherein a width of the first fixing part is greater than a width of the second fixing part.

12. An electrode assembly comprising a first electrode, a second electrode, a separator between the first electrode and the second electrode, and a plurality of an adhesive member,
wherein the first electrode, the second electrode, and the separator are wound to form a first end corresponding to a start position of winding and a second end corresponding to an end position of winding,
wherein the second end is an end of an outermost separator,
wherein the second end comprises a first line and a second line extending in different directions,
wherein one or more of the plurality of the adhesive member is disposed on each of the first line and the second line,
wherein the adhesive member on the first line extends in the longitudinal direction of the first line, and
wherein the adhesive member on the second line extends in the longitudinal direction of the second line.

13. The electrode assembly as claimed in claim 12, wherein the first line and the second line are perpendicular to each other.

14. The electrode assembly as claimed in claim 12, wherein the first line and the second line are not perpendicular to each other.

15. A secondary battery comprising:
a case; and
an electrode assembly of claim 1 accommodated in the case,
wherein the first electrode comprises a first electrode tab,
wherein the second electrode comprises a second electrode tab,
wherein the first electrode tab is connected to a first lead, and
wherein the second electrode tab is connected to a second lead.

16. The secondary battery as claimed in claim 15, wherein the first adhesive member comprises a plurality of a first adhesive part,
wherein the second adhesive member comprises a plurality of a second adhesive part,
wherein the first adhesive member at least partially overlaps the second end,
wherein the second adhesive member does not overlap the second end, and
wherein the first adhesive member comprises a material different than a material of the second adhesive member.

17. The secondary battery as claimed in claim 16, wherein the material of the first adhesive member comprises polystyrene or polyethylene, and
wherein the material of the second adhesive member comprises a silicon-based binder, an acrylate-based binder, or polyvinylidene fluoride.

18. The secondary battery as claimed in claim 16, wherein a melting point of the first adhesive member is greater than a melting point of the second adhesive member.

19. The secondary battery as claimed in claim 16, wherein the first adhesive member and the second adhesive member do not overlap,
wherein the second adhesive member is disposed closer to the electrode tab than the first adhesive member, and
wherein a melting point of the second adhesive member is greater than a melting point of the first adhesive member.
